(19) United States
(12) Patent Application Publication
(10) Pub. No.: US 2008/0289038 A1
(43) Pub. Date: Nov. 20, 2008

(54) METHOD AND APPARATUS FOR CHECKING INTEGRITY OF FIRMWARE

(75) Inventors: Jin-mok KIM, Yongin-si (KR); Jun-bum SHIN, Suwon-si (KR); Hyung-jick LEE, Seongnam-si (KR); Yang-lim CHOI, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/937,856

(22) Filed: Nov. 9, 2007

(30) Foreign Application Priority Data
May 14, 2007 (KR) 10-2007-0046665

(51) Int. Cl. G06F 12/14; G06F 12/02; H04L 9/14

(52) U.S. Cl. 726/22; 380/278; 711/103; 711/E12.091; 711/E12.008

(57) ABSTRACT

Provided are a method and apparatus for checking the integrity of firmware. The method includes storing a first hash function value of unhacked firmware for determining whether actual firmware of an external processor has been hacked; reading the actual firmware via a bus; calculating a second hash function value of the actual firmware; comparing the first hash function value with the second hash function value; and sharing a bus key with the external processor, based on the comparison result.

### CROSS-REFERENCE TO RELATED PATENT APPLICATIONS

This application claims priority from Korean Patent Application No. 10-2007-0046665, filed on May 14, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate to checking the integrity of firmware, and more particularly, to checking the integrity of firmware in order to securely share a bus key between processors.

2. Description of the Related Art

Recently, illegal copying of music or audio visual content is popularly performed and people may obtain illegally copied contents easily. In order to prevent these problems, much attention has been paid to a digital rights management (DRM) method which is a method of protecting content, and usage of the DRM method has increased.

The DRM method is broadly classified into encryption and usage rights. That is, the DRM method prevents an unauthorized person from accessing content by encrypting the content, and also enables content to be utilized only within an authorized scope, by checking the usage rights.

Nonetheless, a third party can decrypt encrypted content or eliminate a content period restriction which limits content to be used only for a predetermined period and can then distribute the content so that anyone can utilize the content.

Accordingly, in order to prevent these problems, the DRM method provides a robustness rule specifying the terms content processors are required to satisfy. Frequently used DRM methods include Digital Transmission Content Protection (DTCP), Window Media Digital Right Management (WMDRM), and Advanced Access Content System (AACS). The robustness rule of these DRM methods generally requires protection of an encryption key, protection of decrypted content within processors against being disclosed externally, and protection of decrypted content against being disclosed to user accessible buses within processors. For example, the user accessible bus may be a peripheral component interconnect (PCI) bus, an integrated drive electronics (IDE) bus, or a universal serial bus (USB).

FIG. 1 is a block diagram illustrating a related art method of establishing enciphered data communication between general processors. Referring to FIG. 1, a first processor 100 and a second processor 110 share a bus key so as to establish communication via a bus. Since the first and second processors 100 and 110 share the bus key, an unauthorized third party cannot access decrypted content. In order to share the bus key, various methods, such as the Diffie-Hellman (DH) algorithm can be used.

Theses methods are advantageous in that if the bus key is securely shared between the first and second processors 100 and 110, the bus can be securely protected against attacks of hackers.

However, if any one of the first and second processors 100 and 110 is hacked, the safety of the bus may not be guaranteed. For example, a hacker can install a backdoor into one processor, e.g., the first processor 100, in order to obtain the bus key, and decrypt data received from the other processor, e.g., the second processor 110, by using the obtained bus key.

### SUMMARY OF THE INVENTION

The present invention provides a method and apparatus for checking the integrity of firmware in order to reduce a possibility that a bus key may be disclosed by hacking a processor.

According to an aspect of the present invention, there is provided a method of checking integrity of firmware, the method comprising storing a first hash function value of unhacked firmware for determining whether actual firmware of an external processor has been hacked; reading the actual firmware via a bus; calculating a second hash function value of the actual firmware; comparing the first hash function value with the second hash function value; and sharing a bus key with the external processor, based on the comparison result.

The reading of the firmware may comprise reading the firmware loaded from a nonvolatile memory of the external processor to a volatile memory of the external processor.

The reading of the firmware may comprise reading the firmware from a nonvolatile memory of the external processor, where the nonvolatile memory comprises flash memory or electrically erasable and programmable read only memory (EEPROM).

The method further comprises establishing enciphered data communication with the external processor, by using the bus key.

One of an electronic signing method and a message authentication code (MAC) method may be used instead of a hash function method.

According to another aspect of the present invention, there is provided a method of checking integrity of firmware, the method comprising storing an offset location and a data size of a part of unhacked firmware for determining whether actual firmware of an external processor has been hacked; storing a first hash function value of the part of unhacked firmware; reading data corresponding to the offset location and the data size from the external processor; calculating a second hash function value of the read data; comparing the first hash function value with the second hash function value; and sharing a bus key with the external processor, based on the comparison result.

The method may further include updating the offset location, the data size, and the first hash function value, based on the comparison result.

The updating of the offset location, the data size, and the first hash function value may include updating the offset location and the data size if the first hash function value is equal to the second hash function value; reading data corresponding to the updated offset location and the updated data size from the external processor; calculating a third hash function value of the read data; and updating the first hash function value to the third hash function value.

The reading of the data corresponding to the updated offset location and the updated data size, the calculating of the third hash function value of the read data, and the updating of the first hash function value, may be repeatedly performed in a predetermined cycle.

The method may further include establishing enciphered data communication with the external processor, by using the bus key.

According to another aspect of the present invention, there is provided a method of checking integrity of firmware, the method including performing integrity check on firmware stored in an external processor; sharing a bus key with the external processor, based on the result of performing integrity check; and establishing enciphered data communication with the external processor, using the bus key.

According to another aspect of the present invention, there is provided an apparatus for checking integrity of firmware, the apparatus comprising a storage unit storing a first hash function value of unhacked firmware for determining whether actual firmware of external processor has been hacked; a firmware reading unit reading the actual firmware via a bus; a hash value calculation unit calculating a second hash function value of the actual firmware; a comparison unit comparing the first hash function value with the second hash function value; and a bus key sharing unit sharing a bus key with the external processor, based on the comparison result.

According to another aspect of the present invention, there is provided an apparatus for checking integrity of firmware, the apparatus comprising a storage unit storing an offset location, a data size, and a first hash function value of a part of unhacked firmware for determining whether actual firmware of an external processor has been hacked; a firmware reading unit reading data corresponding to the offset location and the data size from the external processor; a hash value calculation unit calculating a second hash function value of the read data; a comparison unit comparing the first hash function value with the second hash function value; and a bus key sharing unit sharing a bus key with the external processor, based on the comparison result.

According to another aspect of the present invention, there is provided a computer readable medium having recorded thereon a program for executing a method of checking integrity of firmware, the method comprising storing a first hash function value of unhacked firmware for determining whether actual firmware of an external processor has been hacked; reading the actual firmware via a bus; calculating a second hash function value of the actual firmware; comparing the first hash function value with the second hash function value; and sharing a bus key with the external processor, based on the comparison result.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a related art method of establishing enciphered data communication between general processors;

FIG. 2 is a flowchart illustrating a method of checking the integrity of firmware, according to an exemplary embodiment of the present invention;

FIGS. 3 and 4 illustrate a flowchart of a method of checking the integrity of firmware, according to another exemplary embodiment of the present invention;

FIG. 5 is a flowchart illustrating a method of checking the integrity of firmware, according to another exemplary embodiment of the present invention;

FIG. 6 is a block diagram of an apparatus for checking the integrity of firmware, according to an exemplary embodiment of the present invention; and

FIG. 7 is a block diagram of an apparatus for checking the integrity of firmware, according to another exemplary embodiment of the present invention.

### DETAILED DESCRIPTION OF EXEMPLARY EMBODIMENTS OF THE INVENTION

Exemplary embodiments of the present invention will now be described more fully with reference to the accompanying drawings.

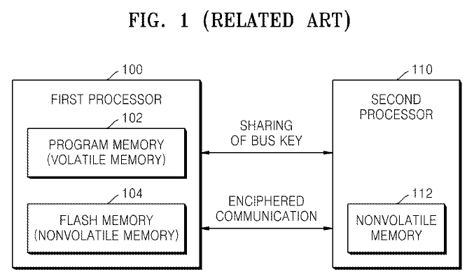

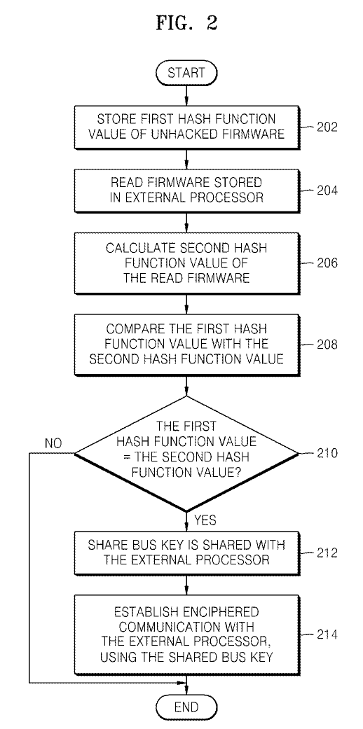

FIG. 2 is a flowchart illustrating a method of checking the integrity of firmware, according to an exemplary embodiment of the present invention. Referring to FIG. 2, a first hash function value of unhacked firmware for determining whether actual firmware has been hacked is stored in a nonvolatile memory 112 of the second processor 110 of FIG. 1 (operation 202). Here, the actual firmware operates the first processor 100 of FIG. 1 and the unhacked firmware is the firmware of an external processor (the first processor 100) used for determining whether the actual firmware has been hacked. However, the first hash function value may not be received from the external processor but may have been previously calculated and stored by a user. The reason for storing a hash function value of firmware that can operate other processors is to perform authentication in order to determine whether the first processor 100, for example, has been hacked by a hacker.

Next, the actual firmware stored in the external processor is read via the bus (operation 204). The actual firmware is used to actually operate the external processor. For example, a nonvolatile memory 104 of the first processor 100 of FIG. 1 stores firmware for actually operating the first processor 100, and thus, the second processor 110 can read the firmware from the nonvolatile memory 104 of the first processor 100. For example, the nonvolatile memory 104 may be flash memory or electrically erasable and programmable read only memory (EEPROM).

According to another exemplary embodiment of the present invention, during operation of the first processor 100, it is possible to read the firmware loaded from the nonvolatile memory 104 to a volatile memory 102 of the first processor 100. This exemplary embodiment is advantageous in that it is possible to prevent a hacker from exposing a bus key by installing in the first processor 100 two firmwares, e.g., firmware on which integrity check (which will later be described in detail) is to be performed and firmware that actually operates.

Next, a second hash function value of the read firmware is stored (operation 206). The read firmware may have been stored in a nonvolatile memory of the external processor or loaded from the nonvolatile memory of the external processor to a volatile memory. Methods of calculating a hash function value of read firmware are well known to those of ordinary skill in the art, and thus a detailed description thereof will be omitted.

Next, the first hash function value is compared with the second hash function value (operation 208). If the second hash function value of the read firmware is equal to the first hash function value of the firmware that has not been hacked, it means that the external processor has not been hacked by a hacker. Adversely, if the second hash function value is not equal to the first hash function value, it means that the external processor has been hacked.

Next, if it is determined that the first and second hash function values are not the same in operation 210, the method is discontinued.

If it is determined that the first and second hash function values are the same in operation 210, a bus key is shared with the external processor (operation 212). For example, in order to share the bus key, various methods, such as the Diffie-Hellman (DH) algorithm, may be used.

Next, an enciphered communication can be established together with the external processor, using the shared bus key (operation 214).

In the method of checking the integrity of firmware illustrated in FIG. 2, according to the current exemplary embodiment, it is possible to obtain the same effect when an electronic signing method or an MAC method is used in place of the above hash function method.

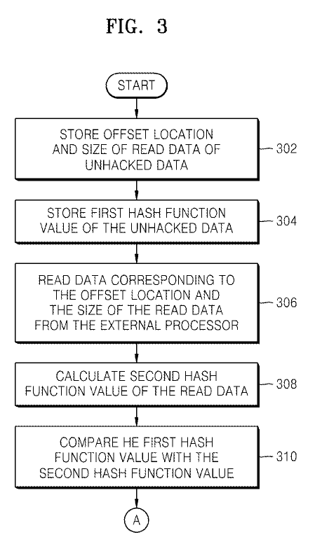

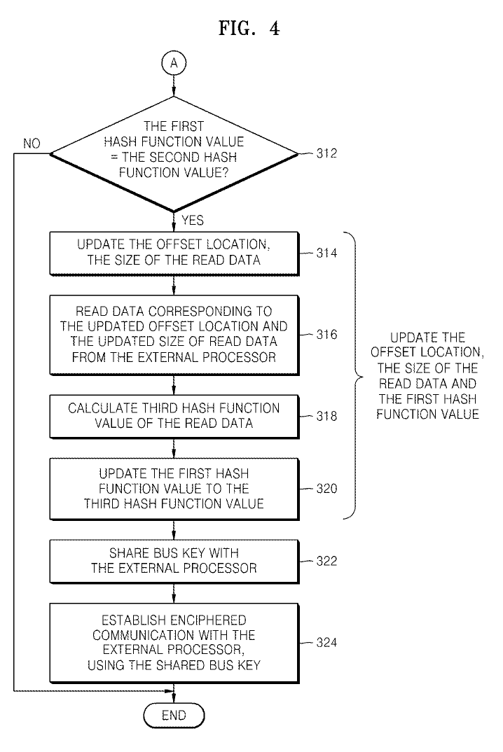

FIGS. 3 and 4 illustrate a flowchart of a method of checking the integrity of firmware, according to another exemplary embodiment of the present invention. Referring to FIGS. 3 and 4, an offset location and a data size of a part of unhacked firmware (unhacked data) for determining whether the actual firmware has been hacked, are stored (operation 302).

The offset location is the starting position of the part of the unhacked firmware. Thus, if data corresponding to the offset location and the data size is read from the external processor, the data corresponding to the data size is read at the offset location. However, the offset location and the data size may not be received from the external processor but may have been previously stored by a user.

Next, a first hash function value of the unhacked data for determining whether the actual firmware has been hacked is stored (operation 304). The first hash function value may not be received from the external processor but instead may have been previously calculated and stored by the user. For example, the nonvolatile memory 112 of the second processor 110 illustrated in FIG. 1 may store the offset location, the data size, and the hash function value of the unhacked data.

Next, the data corresponding to the offset location and the data size (actual data) is read from the external processor via a bus (operation 306). The read data is a part of data that constitutes firmware stored in the external processor.

For example, since the nonvolatile memory 104 of the first processor 100 illustrated in FIG. 1 stores firmware for actually operating the first processor 100, the second processor 110 can read data from the nonvolatile memory 104 of the first processor 100.

According to another exemplary embodiment of the present invention, it is also possible to read data loaded from the nonvolatile memory 104 to the volatile memory 102. The advantage of this exemplary embodiment has been described above.

Next, a second hash function value of the read data is calculated (operation 308). A method of calculating a hash function value of read data is well known to those of ordinary skill in the art, and thus a detailed description thereof will be omitted.

The first hash function value is then compared with the second hash function value (operation 310). As described above, if the second hash function value is equal to the first hash function value, it means that the external processor has not been hacked.

If it is determined that the first hash function value is equal to the second hash function value in operation 312, the method proceeds to operation 314. If it is determined that the first hash function value is not equal to the second hash function value, the method is discontinued.

In operations 314 through 320, the offset location, the data size, and the first hash function value are updated when the first hash function value is equal to the second hash function value.

Specifically, if it is determined that the first hash function value is equal to the second hash function value, the offset location and the data size are updated (operation 314). That is, the starting position and data size of the unhacked data are newly changed. The offset location and the data size can be randomly determined.

Next, data corresponding to the updated offset location and the updated data size is read from the external processor via a bus (operation 316).

A third hash function value of the read data is calculated (operation 318).

Next, the first hash function value is updated to the third hash function value (operation 320).

The process of reading the data corresponding to the offset location and the data size from the external processor and the process of updating the first hash function value may be repeatedly performed in a predetermined cycle, e.g., at predetermined intervals of time or whenever the system is booted.

As described above, data read from an external processor in order to perform authentication is periodically changed, and therefore, can be securely protected against being hacked.

Next, a bus key is shared with the external processor (operation 322). In order to share the bus key, various methods, such as the DH algorithm, can be used.

Thereafter, enciphered communication is established with the external processor, using the shared bus key (operation 324).

Operations 314 through 320 can be performed before or after operations 322 through 324. Also, the method may be discontinued after or without performing operations 314 through 320.

In the method of checking the integrity of firmware according to the current exemplary embodiment, the electronic signing method or the MAC method may be used in place of the hash function method.

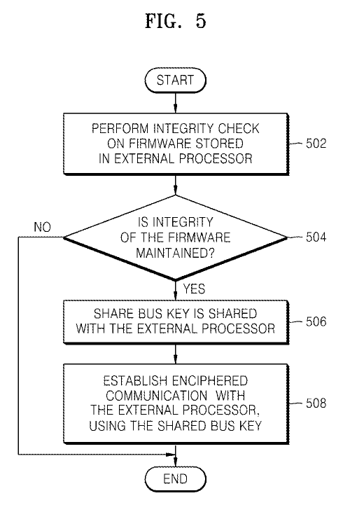

FIG. 5 is a flowchart illustrating a method of checking the integrity of firmware according to another exemplary embodiment of the present invention. Referring to FIG. 5, integrity verification is performed on firmware stored in an external processor (operation 502). Integrity verification is performed in order to determine whether the firmware stored in the external processor has been altered by a hacker.

Next, if it is determined whether the integrity of the firmware stored in the external processor has been maintained, based on the result of performing integrity verification in operation 502 (operation 504), then a bus key is shared with the external processor (operation 506).

Then, an enciphered communication is established with the external processor, using the shared bus key (operation 508).

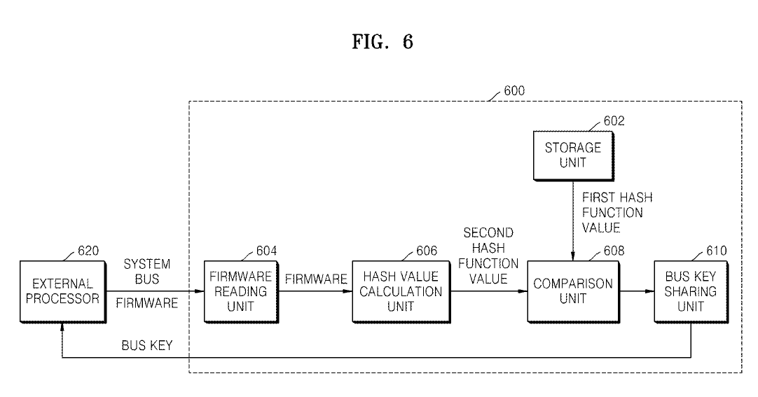

FIG. 6 is a block diagram of an apparatus 600 for checking the integrity of firmware according to an exemplary embodiment of the present invention. Referring to FIG. 6, the apparatus 600 includes a storage unit 602, a firmware reading unit 604, a hash value calculation unit 606, a comparison unit 608, and a bus key sharing unit 610.

The storage unit 602 stores a first hash function value of unhacked firmware for determining whether actual firmware stored in an external processor 620 has been hacked. Although the unhacked firmware is software used to operate the external processor 620, the hash function value (first hash function value) of the unhacked firmware is stored in the storage unit 602 so that it can be used to determine whether the external processor 620 has been hacked.

The firmware reading unit 604 reads the actual firmware from the external processor 620 via a system bus. The actual firmware that has been stored in the external processor 620, is used to actually operate the external processor 620. The firmware reading unit 604 may read the actual firmware from nonvolatile memory, such as flash memory or EEPROM, of the external processor 620.

Also, the firmware reading unit 604 may read actual firmware loaded to nonvolatile memory of the external processor 620. In this case, as described above, it is possible to prevent a hacker from exposing a bus key by installing two or more firmwares, e.g., firmware for receiving authentication and firmware that actually operates, in the external processor 620.

The hash value calculation unit 606 calculates a second hash function value of the actual firmware read from the external processor 602.

The comparison unit 608 compares the first hash function value stored in the storage unit 602 with the second hash function value calculated by the hash value calculation unit 606. For example, if the first hash function value is equal to the second hash function value, the bus key sharing unit 610 is allowed to share a bus key with the external processor 620. However, if the first hash function value is not equal to the second hash function value, the bus key sharing unit 610 is not allowed to share the bus key with the external processor 620, thereby preventing the bus key and encrypted content from being exposed to a hacker.

The bus key sharing unit 610 shares the bus key with the external processor 620.

The apparatus 600 establishes enciphered data communication with the external processor 620, by using the bus key shared by the bus key sharing unit 610.

Alternatively, the apparatus 600 may use the electronic signing method or the MAC method in place of the hash function method.

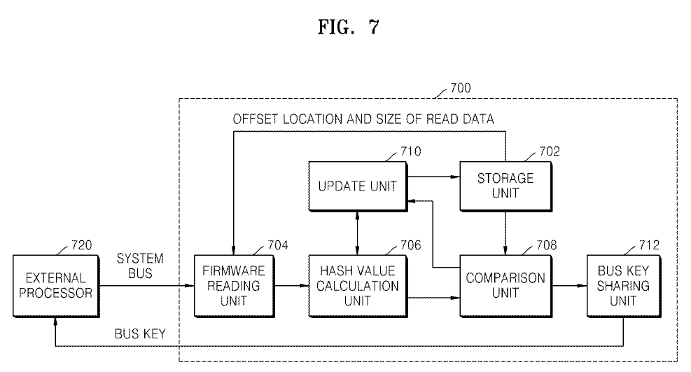

FIG. 7 is a block diagram of an apparatus 700 for checking the integrity of firmware, according to another exemplary embodiment of the present invention. Referring to FIG. 7, the apparatus 700 includes a storage unit 702, a firmware reading unit 704, a hash value calculation unit 706, a comparison unit 708, an update unit 710, and a bus key sharing unit 712.

The storage unit 702 stores an offset location, a data size, and a first hash function value of a part of unhacked firmware (unhacked data). The offset location and the data size may be updated by the update unit 710 (which will later be described in detail) and stored in the storage unit 702. The updated offset location and data size stored in the storage unit 702 may be transmitted to the firmware reading unit 704 in order to read new data from the external processor 720.

The firmware reading unit 704 reads the actual data corresponding to the offset location and the data size from the external processor 720. The firmware reading unit 704 preferably reads data loaded to volatile memory from nonvolatile memory of the external processor 720, as described above. However, it is also possible to read data from the nonvolatile memory, such as flash memory or EEPROM, of the external processor 720.

The hash value calculation unit 706 calculates a hash function value of the read data. Also, the hash value calculation unit 706 calculates a third hash function value of data that is newly read by the firmware reading unit 704 for updating.

The comparison unit 708 compares the first hash function value stored in the storage unit 702 with the second hash function value received from the hash value calculation unit 706. If the comparison result reveals that the first hash function value is equal to the second hash function value, the bus key sharing unit 712 is allowed to share a bus key with the external processor 720 or the update unit 710 is allowed to update the offset location, the data size, and the hash function value that are stored in the storage unit 702.

If receiving an enable signal from the comparison unit 708, the update unit 710 updates the offset location and the data size stored in the storage unit 702, and allows the hash value calculation unit 706 to calculate the third hash function value for the updated offset location and data size of the read data and to transmit the third hash function value to the storage unit 702.

The apparatus 700 establishes enciphered data communication with the external processor 720, using the shared bus key. Also, the apparatus 700 may use the electronic signing method or the MAC method in place of the hash function method.

The present invention can be embodied as computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. The computer readable medium can be distributed among computer systems that are interconnected through a network, so that the computer readable code can be stored in the distributed system and executed according to a distribution method.

As described above, in a method and apparatus for checking the integrity of firmware according to the present invention, a hash function value of unhacked firmware is compared with a hash function value of firmware read from an external processor, thereby minimizing a possibility that a bus key will be exposed by hacking of the external processor.

Also, firmware downloaded to a volatile memory from a nonvolatile memory of an external processor is read, thereby preventing firmware installed by a hacker from operating.

Also, an offset location, a data size, and a hash function value are updated, thus minimizing a possibility that a bus key will be disclosed due to hacking by an external processor.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of checking integrity of firmware, the method comprising:
storing a first hash function value of unhacked firmware for determining whether firmware of an external processor has been hacked;
reading the firmware via a bus;
calculating a second hash function value of the firmware;
comparing the first hash function value with the second hash function value; and
sharing a bus key with the external processor, based on a result of the comparing.

2. The method of claim 1, wherein the reading of the firmware comprises reading the firmware loaded from a nonvolatile memory of the external processor to a volatile memory of the external processor.

3. The method of claim 1, wherein the reading of the firmware comprises reading the firmware from a nonvolatile memory of the external processor, where the nonvolatile memory comprises a flash memory or an electrically erasable and programmable read only memory.

4. The method of claim 1, further comprising establishing enciphered data communication with the external processor, by using the bus key.

5. A method of checking integrity of firmware, the method comprising:
storing an offset location and a data size of a part of unhacked firmware for determining whether firmware of an external processor has been hacked;
storing a first hash function value of the part of the unhacked firmware;
reading data corresponding to the offset location and the data size from the external processor;
calculating a second hash function value of the read data;
comparing the first hash function value with the second hash function value; and
sharing a bus key with the external processor, based on a result of the comparing.

6. The method of claim 5, further comprising updating the offset location, the data size, and the first hash function value, based on the result of the comparing.

7. The method of claim 6, wherein the updating the offset location, the data size, and the first hash function value comprises:
updating the offset location and the data size if the first hash function value is equal to the second hash function value;
reading data corresponding to the updated offset location and the updated data size from the external processor;
calculating a third hash function value of the read data; and
updating the first hash function value to the third hash function value.

8. The method of claim 7, wherein the reading the data corresponding to the updated offset location and the updated data size, the calculating of the third hash function value of the read data, and the updating of the first hash function value are repeatedly performed in a predetermined cycle.

9. The method of claim 5, wherein the reading the data corresponding to the offset location and the data comprises reading data loaded from a nonvolatile memory of the external processor to a volatile memory of the external processor.

10. The method of claim 5, wherein the reading the data corresponding to the offset location and the data size comprises reading the data from a nonvolatile memory of the external processor, and the nonvolatile memory comprises a flash memory or an electrically erasable and programmable read only memory.

11. The method of claim 5, further comprising establishing enciphered data communication with the external processor, by using the bus key.

12. A method of checking integrity of firmware, the method comprising:
performing an integrity check on firmware stored in an external processor;
sharing a bus key with the external processor, based on a result of the performing the integrity check; and
establishing enciphered data communication with the external processor, using the bus key.

13. An apparatus for checking integrity of firmware, the apparatus comprising:
a storage unit which stores a first hash function value of unhacked firmware for determining whether firmware of an external processor has been hacked;
a firmware reading unit which reads the firmware via a bus;
a hash value calculation unit which calculates a second hash function value of the firmware;
a comparison unit which compares the first hash function value with the second hash function value; and
a bus key sharing unit which shares a bus key with the external processor, based on a comparison result of the comparison unit.

14. The apparatus of claim 13, wherein the firmware reading unit reads firmware loaded from a nonvolatile memory of the external processor to a volatile memory of the external processor.

15. The apparatus of claim 13, wherein the firmware reading unit reads the firmware from a nonvolatile memory of the external processor, and the nonvolatile memory comprises a flash memory or an electrically erasable and programmable read only memory.

16. The apparatus of claim 13, wherein the bus key is used in establishing enciphered data communication with the external processor.

17. An apparatus for checking integrity of firmware, the apparatus comprising:
a storage unit which stores an offset location, a data size, and a first hash function value of a part of unhacked firmware for determining whether firmware of an external processor has been hacked;
a firmware reading unit which reads data corresponding to the offset location and the data size from the external processor;
a hash value calculation unit which calculates a second hash function value of the read data;
a comparison unit which compares the first hash function value with the second hash function value; and
a bus key sharing unit which shares a bus key with the external processor, based on a comparison result received from the comparison unit.

18. The apparatus of claim 17, further comprising an update unit which updates the offset location, the data size, and the first hash function value, based on the comparison result received from the comparison unit.

19. The apparatus of claim 17, wherein the firmware reading unit reads data loaded from a nonvolatile memory of the external processor to a volatile memory of the external processor.

20. The apparatus of claim 17, wherein the firmware reading unit reads the data from a nonvolatile memory of the external processor, and the nonvolatile memory comprises a flash memory or an electrically erasable and programmable read only memory.

21. The apparatus of claim 20, wherein the bus key is used in establishing enciphered data communication with the external processor.

22. A computer readable medium having recorded thereon a program for executing a method of checking integrity of firmware, the method comprising:
storing a first hash function value of unhacked firmware for determining whether firmware of an external processor has been hacked;
reading the firmware via a bus;
calculating a second hash function value of the firmware;
comparing the first hash function value with the second hash function value; and
sharing a bus key with the external processor, based on a result of the comparing.
